(19) United States
(12) Patent Application Publication
(10) Pub. No.: US 2026/0338289 A1
(43) Pub. Date: Oct. 29, 2026

(54) DISPENSERS AND REFILL UNITS HAVING STRETCH VALVES

(71) Applicant: GOJO Industries, Inc., Akron, OH (US)

(72) Inventors: Christopher M. Gorman, North Canton, OH (US); John J. McNulty, Broadview Heights, OH (US); Nick E. Ciavarella, Seven Hills, OH (US)

(21) Appl. No.: 19/117,739

(22) PCT Filed: Oct. 6, 2023
(86) PCT No.: PCT/US2023/076188

§ 371 Date: Apr. 2, 2025

Related U.S. Application Data
(60) Provisional application No. 63/414,037, filed on Oct. 7, 2022.

(51) Int. Cl. F16K 21/04; A47K 5/12; B65D 47/04; F16K 23/00

(52) U.S. Cl. CPC F16K 21/04; A47K 5/12; B65D 47/04; F16K 23/00

(57) ABSTRACT

An refill unit for a soap or sanitizer dispenser includes a container and a closure. The closure has a cylindrical wall forming an opening through the closure. The cylindrical wall has an upper surface that forms a valve seat and the cylindrical wall having a lower portion. The refill unit includes a stretch valve having a body, an annular channel, and one or more fluid passageways therethrough. The stretch valve stretches to move from a closed position to an open position and is a normally closed valve. The one or more fluid passageways are located below the valve seat when the stretch valve is in a closed position and the one or more fluid passageways are at least partially located above the valve seat when the valve is in an open position.

### TECHNICAL FIELD

The present invention relates generally to dispensers and more particularly to dispensers having refill units with stretch valves.

### BACKGROUND OF THE INVENTION

Dispensers, such as, for example, soap and sanitizer dispensers, often include a refill unit that may be inserted into a dispenser and removed from the dispenser when empty. The refill units typically consist of a container used in an inverted position. The container has a neck located at the bottom and are typically sealed with a seal that is punctured when the refill unit is inserted into the dispenser. When the refill is removed, residual soap or sanitizer drains out of the container and makes a mess. Some refill units have a slit valve that reseals the opening when the refill is removed, however, those refill units are subject to leaking if too much pressure is applied to the refill unit during transport or installation.

### SUMMARY

Exemplary soap or sanitizer dispensers and refill units are disclosed herein. An exemplary refill unit for a soap or sanitizer dispenser includes a container and a closure. The closure has a cylindrical wall forming an opening through the closure. The cylindrical wall has an upper surface that forms a valve seal and the cylindrical wall having a lower portion. The refill unit includes a stretch valve. The stretch valve has a body, a valve seal, a retention flange, an annular channel, and one or more fluid passageways therethrough. The body of the stretch valve is located on the interior of the cylindrical wall. The lower portion of the cylindrical wall is located in the annular channel of the stretch valve. The stretch valve stretches to move from a closed position to an open position and is a normally closed valve. The one or more fluid passageways are located below the valve seat when the stretch valve is in a closed position and the one or more fluid passageways are at least partially located above the valve seat when the vale is in an open position.

Another exemplary refill unit for a soap or sanitizer dispenser includes a container and a closure. The closure has a cylindrical wall forming an opening through the closure. The cylindrical wall has an upper surface that forms a valve seal and the cylindrical wall has a lower extending portion. The refill unit includes a stretch valve. The stretch valve has a body, a valve seal, a retention flange, an annular channel, one or more openings therethrough and a sealing bead located on the interior of the valve body. The body of the stretch valve is located on the interior of the cylindrical wall. The lower extending portion of the cylindrical wall is located in the annular channel of the stretch valve. The one or more openings are located below the valve seat when the stretch valve is in a closed position and the one or more openings are at least partially located above the valve seat when the vale is in an open position.

Another exemplary refill unit for a soap or sanitizer dispenser includes a container and a closure. The closure has a cylindrical wall forming an opening through the closure. The cylindrical wall having an upper surface that forms a valve seal and a lower extending portion. The refill unit further includes a stretch valve. The stretch valve has a body, a valve seal, a retention flange, an annular channel, and one or more fluid passageways therethrough. The one or more fluid passageways have an outer opening on the exterior of the valve body and an inner opening on the interior of the valve body. The outer opening is larger than the inner opening. The body of the stretch valve is located on the interior of the cylindrical wall. The lower extending portion of the cylindrical wall is located in the annular channel of the stretch valve. The one or more openings are located below the valve seat when the stretch valve is in a closed position and the one or more openings are at least partially located above the valve seat when the vale is in an open position.

An exemplary stretch valve includes a body, a valve seal, a retention flange, an annular channel, and one or more fluid passageways. The one or more fluid passageways have an outer opening on the exterior of the valve body and an inner opening on the interior of the valve body. The outer opening is larger than the inner opening. The valve body is elastomeric and stretches to move from an open position to a closed position. The one or more fluid passageways are sealed prior to the first time the stretch valve is moved from a closed position to an open position.

### BRIEF DESCRIPTION OF THE DRAWINGS

To further clarify various aspects of the present disclosure, a more particular description of inventive concepts will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale. Features and advantages of the present disclosure will be described and explained with additional specificity and detail through the use of the accompanying drawings in which:

FIG. 1 is an exemplary soap or sanitizer dispenser system;

FIG. 2 is a prospective view of an exemplary dispenser base;

FIG. 3 is a perspective view of an exemplary dispenser spout;

FIG. 4 is an exploded view of an exemplary refill unit for a soap or sanitizer dispenser system;

FIG. 5 is a perspective view of the exemplary refill unit of FIG. 4 prior to insertion into a pump house receptacle;

FIG. 6 is a perspective view of the exemplary refill unit of FIG. 4 inserted into the pump house receptacle of FIG. 5;

FIGS. 7 and 7A are prospective views of an exemplary latching arm;

FIG. 8 is a top prospective view of the pump house receptacle of FIG. 5;

FIG. 9 is a prospective view of an exemplary key collar;

FIG. 10 is a cross-sectional view of the exemplary pump house and reservoir;

FIG. 11 is an exploded view of an exemplary refill unit;

FIG. 12 is a cross-sectional view of the refill unit of FIG. 11 over a portion of a dispenser;

FIG. 13 is a cross-sectional view of the refill unit of FIG. 11 inserted into the portion of the dispenser of FIG. 12;

FIG. 14 is a prospective view of an exemplary stretch valve;

FIG. 15 is a cross-section of the exemplary stretch valve of FIG. 14;

FIG. 16 is a cross-section of the exemplary stretch valve of FIG. 14 in a stretched or open position;

FIG. 17 is s cross-section of a closure;

FIG. 18 is a prospective view of an exemplary stretch valve;

FIG. 19 is a cross-section of the exemplary stretch valve of FIG. 18;

FIG. 20 is a cross-section of the exemplary stretch valve of FIG. 18 in a stretched position or open position;

FIG. 20A is a prospective view of an exemplary post;

FIG. 20B is a cross-section of the exemplary post;

FIG. 21 is a cross-section of the exemplary stretch valve; and

FIG. 22 is a cross-section of the exemplary stretch valve of FIG. 21 in a stretched position or open position.

### DETAILED DESCRIPTION

The following description refers to the accompanying drawings, which illustrate specific aspects of the present disclosure.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Also as described herein, the terms “substantially” and “about” are defined as at least close to (and includes) a given value or state (preferably within 10% of, more preferably within 1% of, and most preferably within 0.1% of).

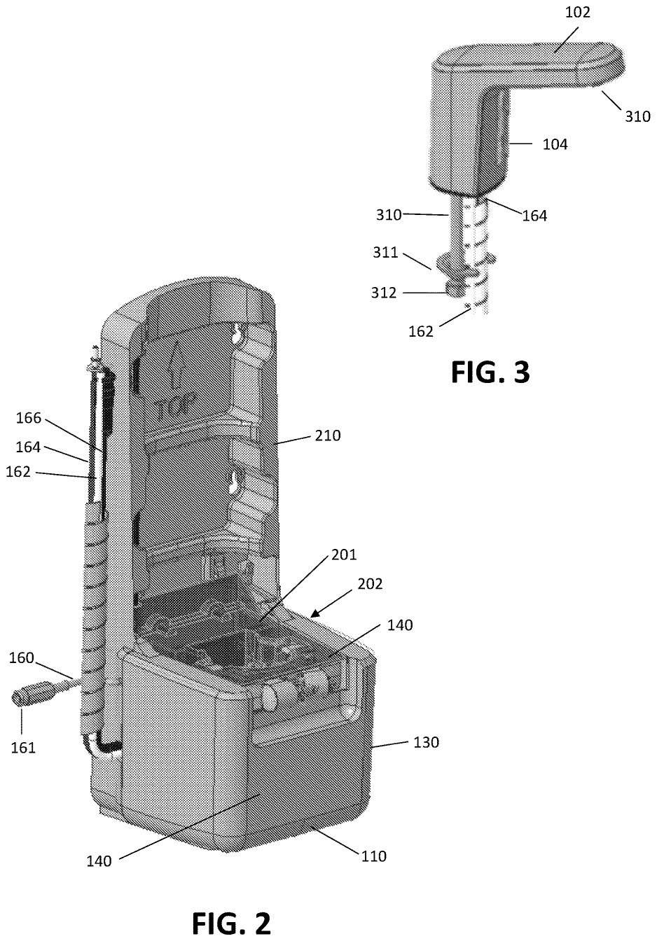

An exemplary soap or sanitizer dispenser system 100 is illustrated in FIG. 2. The exemplary dispenser system 100 is a counter-mount dispenser system. The inventive concepts described herein may be used in other dispenser systems, such as for example, table-top dispensers, wall-mounted dispensers, stand-mounted dispensers and the like. Dispenser system 100 includes a spout 102 mounted to a countertop 103. Dispenser system 100 is a touch-free dispenser system. The inventive concepts may be used in a manual system. Spout 102 includes an optional sensor 104. Sensor 104 detects the presence of a hand in the dispensing area and upon such detection, a processor (not shown) causes a dose of fluid to be dispensed to a user's hands. The optional sensor 104 is preferably an infrared (IR) sensor, but may be another type of dispenser, such as, for example, a capacitance sensor, an ultrasonic sensor, a heat detection sensor, or the like. An exemplary sensor 104 is shown and described in co-pending U.S. Provisional Pat. Application Serial No. 63/388371, titled Touch Free Dispensers Having Improved hand Sensing, which is incorporated herein by reference in its entirety. Sensor 104 may be mounted remotely from the spout 102. As shown in FIG. 3, spout 102 includes a threaded rod 310, a u-shaped plate and a nut 312 for mounting spout 102 to countertop 103.

Dispenser system 100 is a foam-at-a-distance dispenser. Liquid is pumped up to a mixing chamber (not shown) in spout 102 through conduit 164 and air is pumped up to the mixing chamber (not shown) through conduit 162. The air and liquid are mixed in the mixing chamber (not shown) and are dispensed out of outlet 310 in the form of a foam. Exemplary foam-at-a-distance spouts and mixing chambers are shown and described in co-pending U.S. Provisional Pat. Application Ser. No. 63/311,663 titled Remote Foam Generators and Foam At A Distance Dispenser Systems, U.S. Provisional Patent Application Ser. No. 63/311,225, titled Reduced Loss Of Prime Foam-At-A-Distance Dispenser Systems, which are incorporated herein by reference in their entirety. Electrical cable 166 provide power to sensor 104 and provides signals from sensor 104 to a processor (not shown) in dispenser base 130. Although dispenser 100 is a foam-at-a-distance dispenser, the inventive concepts may be used with a liquid dispenser, a foam near the pump dispenser, a counter mount dispenser, a wall mount dispenser or the like.

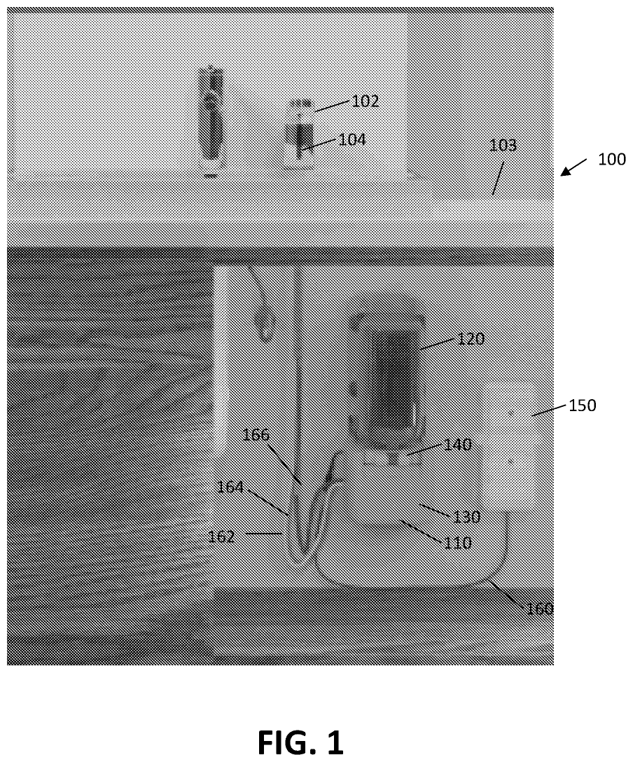

Dispenser system 100 is powered by a battery pack 150. Battery pack 150 may be one or more batteries. Dispenser system 100 may be powered by other means, such as, for example, solar power, focused energy power systems, 115 VAC systems with power converters, or the like. Power cable 160 extends from battery pack 150 to dispenser base 130. Dispenser base 130 has an optional backplane 210. Backplane 210 may be mounted to a back wall as shown in FIG. 1. Backplane 210 may be mounted to a side wall. Optionally, dispenser base 130 may be configured to sit on the floor below the counter. Dispenser base 130 may be attached to the floor. Power cable 160 may include one or more connectors 161. Connectors 161 may facilitate shipping. Connectors 161 may also make installation easier with the ability to add length to cable 160 without having to splice wires.

Base 130 has an optional shell 110. Shell 110 provides protection to the components located within dispenser base 130. Components located within base 130 include, for example, a processor (not shown), memory (not shown), one or more motors (not shown), one or more pumps (not shown). Exemplary pumps are shown and described in U.S. Pat. No. 10,143,339 which is incorporated herein by reference in its entirety. Additional components may also be included, such as, for example, an encoder for counting motor or pump revolutions to control dose size, or the like.

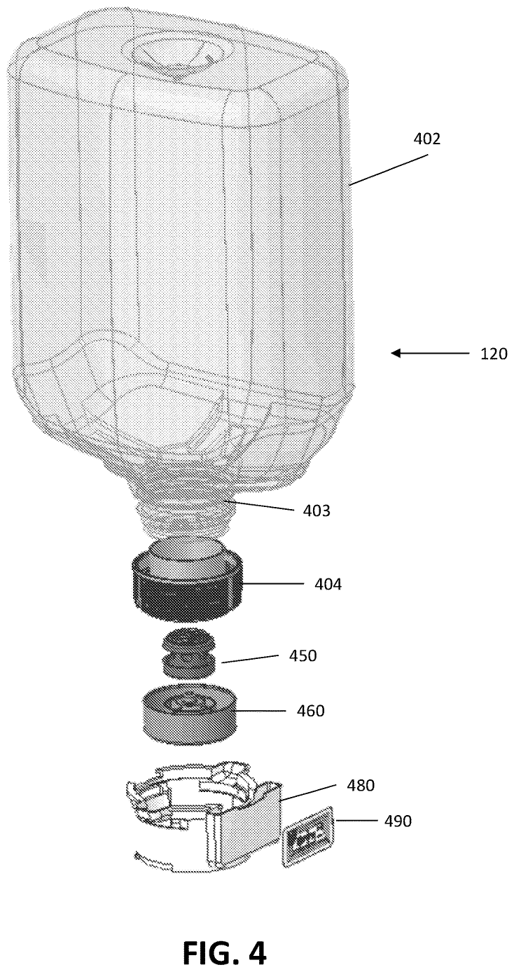

Dispenser system 100 includes a pump housing 201. Pump housing 201 includes a receptacle 202. In addition, pump housing 201 includes a pair of latching arms 140. Although a pair of latching arms 140 are shown and described, one latching arm 140 may be used. Receptacle 202 receives the neck 403 (FIG. 4) of container 402.

FIG. 4 illustrates an exemplary refill unit 120 that may be used in dispenser system 100. Refill unit 120 includes a container 402. Container 402 includes a neck 403, a closure 404, a valve 450 and an optional dust cap 460. Refill unit 120 may also include a key collar 480. Valve 450 is a normally closed valve that may be opened up to allow liquid to flow out of container 402. Valve 450 may also allow air up into container 402. Optional valve cover 460 may be included to keep valve 450 clean and from dust and debris prior to the valve cover 460 being removed and the refill unit 120 being installed in the dispenser. In addition, the valve cover 460 may be included aid in valve 450 retention during distribution. The valve cover 460 can be a plastic injection molded component, adhesive peel seal, or induction heat seal. Closure 404 is connected to neck 403. Closure 404 may be connected to neck 403 by any means, such as, for example, a threaded connection, a welded connection, a glued connection, a snap-fit connection, a friction fit connection, or the like. Key collar 480 fits over closure 404 and includes an optional key 490. Optional key 490 is a memory device, such as, for example, and RFID. Optional key 490 may be a read-only key or a read-write key. Optional key 490 may contain information relating to the refill unit, such as, for example, volume of refill, volume remaining in refill, type of fluid in refill, manufacturing date, expiration date, dose size, and the like.

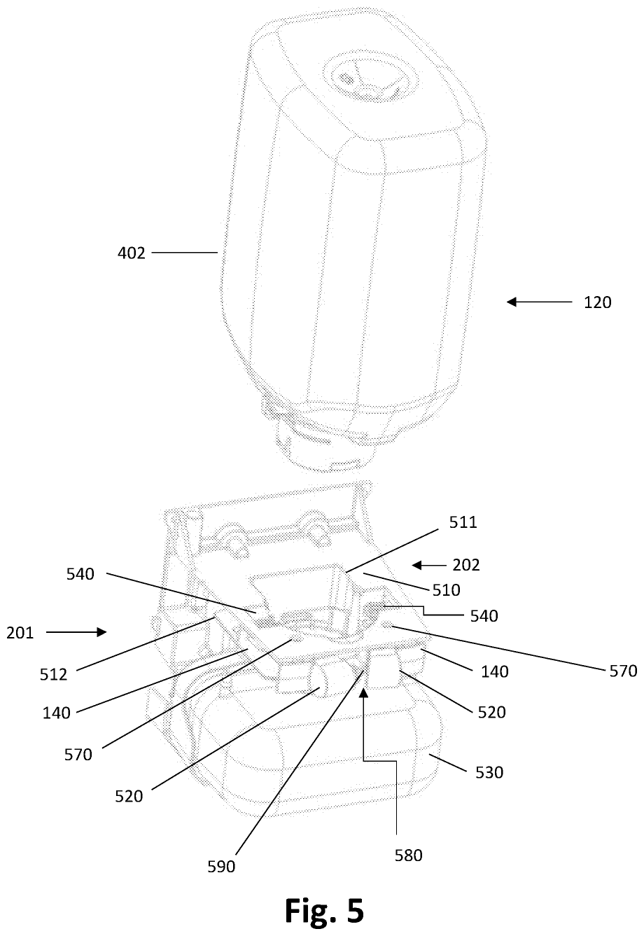

FIG. 5 illustrates pump housing 201 with shell 110 and backplane 210 of dispenser base 130 removed (other components have been removed for clarity). Refill unit 120 is removed from pump housing 201. A reservoir 530 is located in pump housing 201. Reservoir 530 receives fluid from container 402, and the fluid from reservoir 530 is pumped to the spout 102 when the dispenser system 100 is dispensing.

Pump housing 201 includes an upper plate 511. Upper plate 511 has an opening 511. A pair of latching arms 140 are secured to pump housing 201. Although a pair of latching arms are shown, the inventive concepts may utilize only one latching arm. Latching arms 140 include a latch 540. Latching arms 140 are shown in an unlatched position 580.

Latch 540 may have a sloped or ramped upper surface that slopes downward toward the end of the latch 540. If the latching arms 140 are in the latched position when a refill unit 120 is inserted into the dispenser 130, the downward sloped surface causes the latch arms 140 to be pushed outward so that the refill unit 120 may be inserted into the dispenser even though the latch arms 140 are not locked or retained in their unlatched position 580.

A biasing member 590 biases the latching arms 140 toward the latched position. The biasing member 590 may be, for example, a spring, an elastomeric member, a rubber member, or the like. The spring may be a metal spring or a plastic spring.

Latching arms 140 pivot with respect to the pump housing, i.e. the latching arms 140 have a pivot point. Pump housing 201 includes an optional lower plate 512. Upper plate 511 includes apertures 570. Apertures 570 are circular in shape. Lower plate includes apertures (not shown) directly below apertures 570. Latching arms 140 include optional cylindrical projection 710 and optional cylindrical projection 710A, which fit into apertures 570 and the apertures (not shown) in lower plate 512. In some embodiments, latching arms 140 move inward and outward in a linear path, rather than an arcuate path. In such applications, aperture 570 may be, for example, an elongated slot. These applications may require additional biasing members.

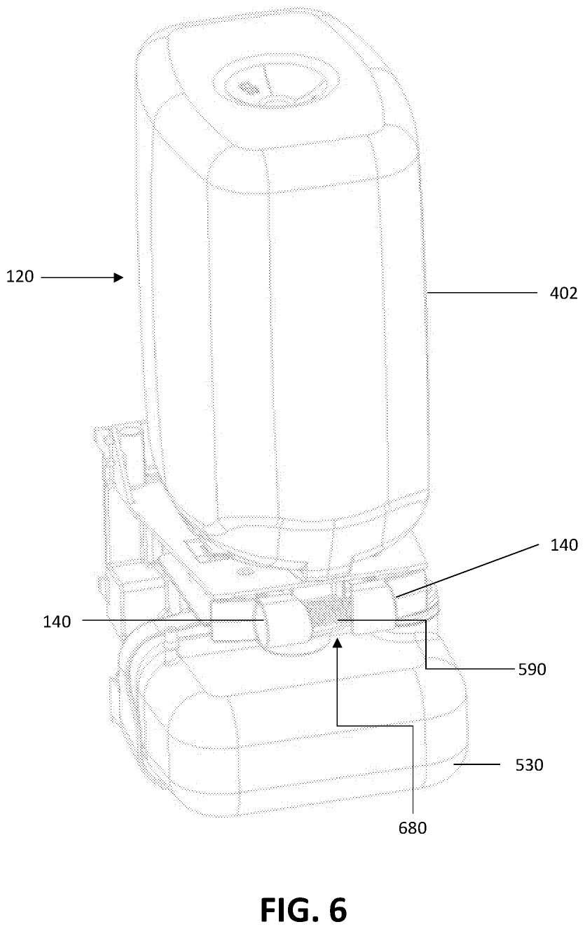

Latching arms 140 include engagement surfaces 520. Engagement surfaces 520 are engaged by a user to move the latching arms 140 from the latched position 680 (FIG. 6) to the unlatched position 580.

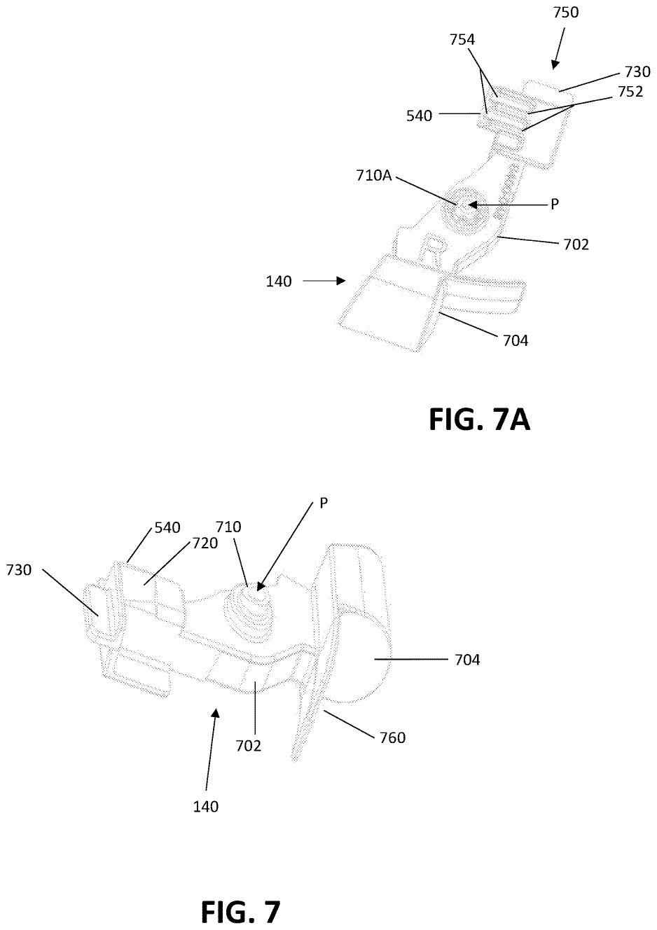

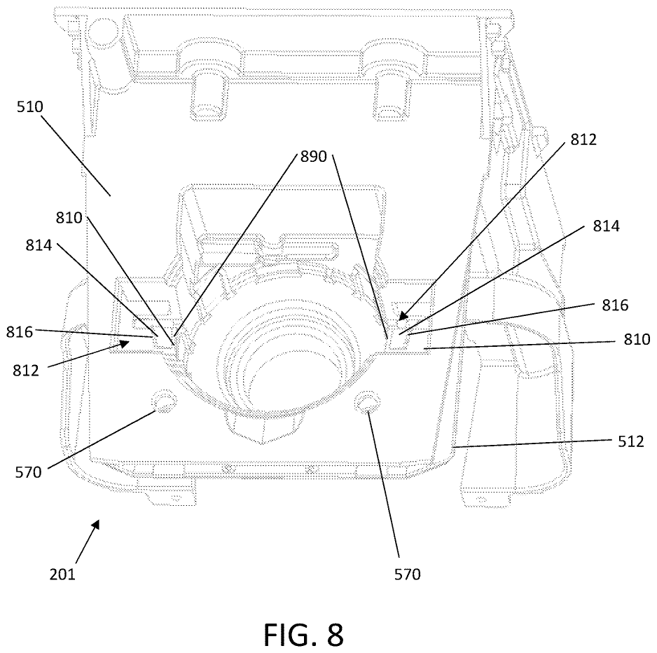

FIG. 7 is a prospective top view of a latching arm 140 and FIG. 7A is a prospective bottom view of the latching arm 140. Latching arm 140 has a body 702. The illustrated latching arm 140 includes a cylindrical projection 710 and 710A located at pivot point P. Cylindrical projections 710 and 710A may be replaced with one or more cylindrical openings and cylindrical projections may be located on the upper plate 510 and lower plate 510. Latching arm 140 and upper plate 510 and lower plate 512 may each have cylindrical openings and a pin (not shown) may be used to attach latching arm 140 to upper plate 510 at the pivot point P. Body 702 includes an optional finger guide 760. Body 702 includes an optional guide plate 730. Optional guide plate 730 is configured to ride along a projection (not shown) on one of the upper plate 510 and the lower plate 512 to prevent latching arm 140 from upward or downward movement.

Latching arm 140 includes an engagement member 750. Engagement member 750 includes an arm engagement surface 752. In addition, engagement member 750 includes a surface 754. Surface 754 may optional be a sloped or ramped surface. Engagement member may be a projection. Engagement member may have numerous shapes and sizes provided engagement member 750 includes an arm engagement surface 752. Arm engagement surface 752 may be flat vertical surface. Arm engagement surface 752 may have an angled surface. The angled surface may form an “undercut”. An undercut may aid in retaining the latching arm 140 in the unlatched position 680. Arm engagement surface 752 may have an angled surface with a rounded top portion.

Lower plate 512 includes retaining members 812. Retaining members 812 have a retaining member engagement surface 816. Retaining member engagement surface 816 may be flat vertical surface. Retaining member engagement surface 816 may have an angled surface. The angled surface may form an “undercut”. An undercut on one or both of retaining member engagement surface 816 and arm engagement surface 752 may aid in retaining latching arm 140 in the unlatched position. Retaining members 812 may have a sloped or ramped surface 814.

Retaining members 812 are located on a flexible tab 810. Flexible tabs 810 is a resilient member that may be deflected and is biased toward its undeflected position. Flexible tabs 810 may be tabs cut into a portion of lower plate 512. Flexible tabs 810 include a release engagement surface 890. Release engagement surface 890 may be located at an outer end of the flexible tab 810. Release engagement surface 890 may be engaged by contact surface 912 of release member 910 as described below to deflect flexible tab 810.

When latching arms 140 are moved from their latched position 580 to their unlatched position 680, engagement surface 752, which may be a sloped or ramped surface, is engaged by surface 752 of arm engagement member. The flexible tabs 810 deflect downward. When arm engagement surface 752 passes the end of surface 814, the flexible tabs 810 move upward so that arm engagement surface 752 contacts retaining member engagement surface 816. Thus, latching arms 140 are retained or locked in an unlatched position. The user can release engagement arms 140 and engagement arms 140 remain in an unlatched position.

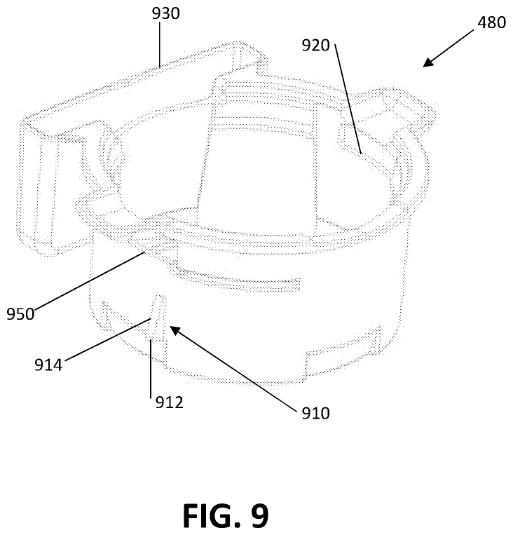

FIG. 9 is a prospective view of an exemplary optional key collar 480. Optional key collar 480 snap fits over closure 404. Key collar 480 includes a pocket 930 for receiving a key (not shown). In addition, this exemplary key collar 480 includes a pair of slots 950. Slots 950 are configured so that latch 540 passes through slots 950 which allows the latches 540 to latch onto the closure 408 to retain the refill unit 120 in place. In addition, if the key collar 480 is rigidly secured to closure 408, latches 540 may latch onto slots 950.

Located on key collar 480 is a pair of latch release members 910. Latch release members 910 are on key collar 480, however, latch release members 910 may be located on any part of the refill unit 120, such as, for example, on closure 404. Latch release members 910 include a release member contact surface 914. Optionally, latch release members 910 include a sloped surface 914.

When refill unit 120 is lowered into receptacle 202, latch release member 910 contacts release engagement surface 890 of flexible tab 810. The engagement causes flexible tab 810 to deflect downward. As flexible tab 810 moves downward, latching arm retaining surface 752 disengage from retaining member engagement surface 816. Biasing member 590 causes the latching arms 140 to move toward the latching position 680.

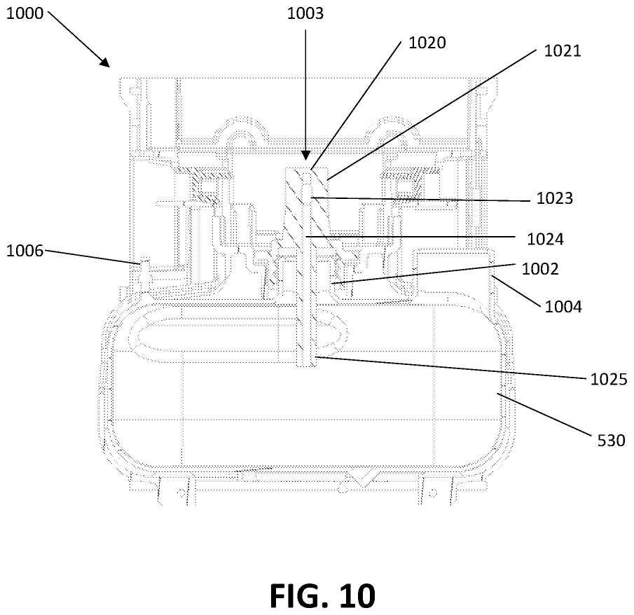

FIG. 10 is a cross-section of a portion of a dispenser base 1030. Reservoir 530 is a sealed reservoir and includes a neck 1002. Attached to neck 1002 is a valve post 1003. Valve post 1003 engages valve 450 and opens valve 450 when refill unit 120 is inserted into dispenser base 130. Valve post 1003 includes a valve contact surface 1020. Valve post 1003 includes one or more apertures 1023 from an outside surface 1021 of valve post 100 to an interior hollow passage 1024. A tube 1025 extends downward into reservoir 530. Optionally, valve post 1003 includes one or more passages that allow air in reservoir 530 to flow up into container 402 as liquid is drawn out of container 402.

Reservoir 530 includes an optional opening 1004. Optional opening 1004 may be used to attach a float to the reservoir 530. A float (not shown) may be used to determine a level of fluid in the reservoir 530.

Reservoir 530 includes an optional opening 1006. Opening 1006 may be used to vent reservoir 530 when fluid is added to reservoir 530.

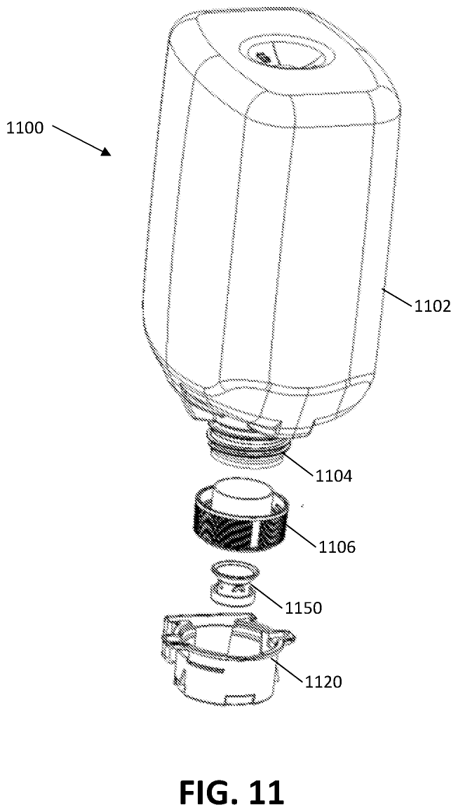

FIG. 11 is an exploded view of an exemplary refill unit 1100. Refill unit 1100 includes a container 1102, a closure 1106, a stretch-valve 1150 and an optional key collar 1120. Key collar 1120 is similar to key collar 480 and is not redescribed herein. Closure 1106 is secured to the neck 1104 of container 1102. Closure 1106 may be connected to neck 1104 by, for example, a threaded connection (as shown), a snap fit connection, a friction fit connection, a welded connection or the like.

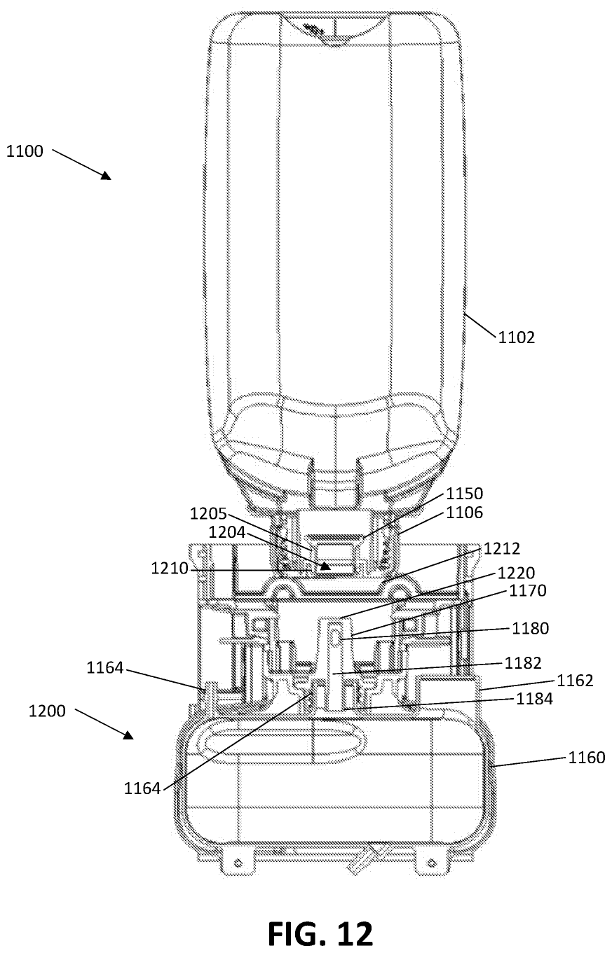

Closure 1106 includes an cylindrical opening 1204 (FIG. 17 is a larger view of the closure 1106). Opening 1204 is formed by cylindrical projection 1205 (FIG. 12). Cylindrical projection 1205 has a lower wall portion 1210. A valve retention channel 1212 is located in the closure 1206 around the lower wall portion 1210 of cylindrical projection 1205. Located at the top of cylindrical projection 1205 is a valve seat 1700. Valve seat 1700 is an angled surface. In some instances, the angled surface may be between 0 degrees to 80 degrees. In some instances, the angled surface may be between 20 degrees to 70 degrees. In some instances, the angled surface may be between 30 degrees to 60 degrees. In some instances, the angled surface may be between 40 degrees to 50 degrees. In some instances, the angled surface may be about 45 degrees. Cylindrical projection 1205 has an upper surface 1702. The closure 1106 is shown in the position that closure 1106 will be in when connected to a container 1102 and the refill unit 1100 is installed in a dispenser. Accordingly, references to top surface or bottom surface, is related to the position closure 1106 is shown in FIG. 17 and the position that closure 1106 is when it is in a dispenser. Closure 1106 has a bottom surface 1214.

The stretch valve 1150 is secured to closure 1106 as described in more detail below. The stretch valves disclosed herein may be over molded to the closures, rather than attaching the stretch valves to the closures.

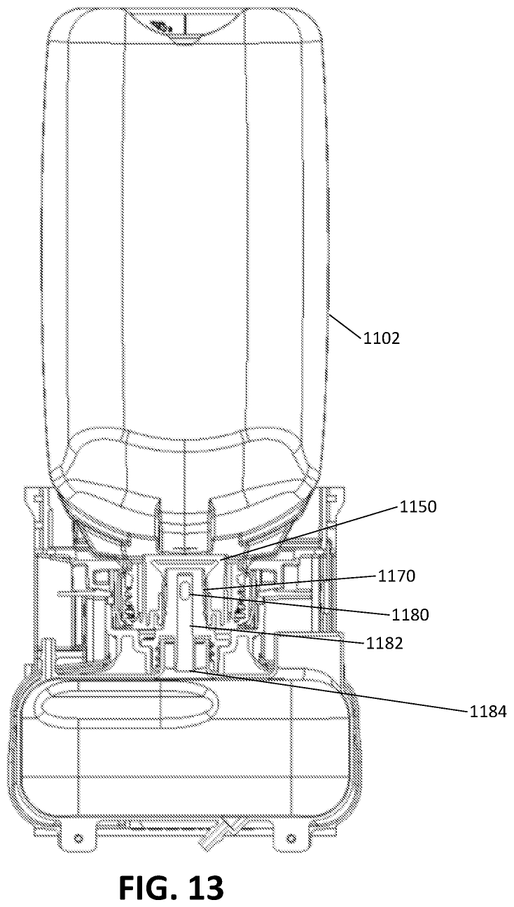

FIG. 12 is a cross-sectional view of a portion of a dispenser 1200 and refill unit 1102 shown removed and above the dispenser 1200. Dispenser 1200 includes a reservoir 1160. Reservoir 1160 is a sealed reservoir and includes a neck 1202. Although the dispenser 1200 includes a sealed reservoir, the inventive concepts may be used with dispensers that do not contain a reservoir and fluid from the refill unit 1102 may be fed directly to a pump. Attached to neck 1202 is a valve post 1170. Valve post 1170 includes a valve contact surface 1220. Valve post 1170 includes one or more apertures 1180 therethrough providing a fluid flow path through valve post 1170 to an interior hollow passage 1182. A tube 1184 extends downward into reservoir 1160. Optionally, valve post 1173 includes one or more passages that allow air in reservoir 1160 to flow up into container 1102 as liquid is drawn out of container 1102. The one or more passages for allowing air to flow into the container 1102 may be separate from the passage that allows liquid to flow out of the container 1102. Optionally, apertures 1180 may be replaced or supplemented by castellations (not shown) at the top of the valve post 1173 providing a passage from the exterior of the valve post 1173 to the interior passage 1182. As described in more detail below, as refill unit 1102 is lowered into dispenser 1200, valve post 1170 contacts valve 1150 causing valve 1150 to stretch. When the valve 1150 is stretched, passageways in the valve 1150 allow fluid to flow therethrough. FIG. 13 illustrates the refill unit 1100 fully inserted in dispenser 1200 and stretch valve 1150 in its fully opened position.

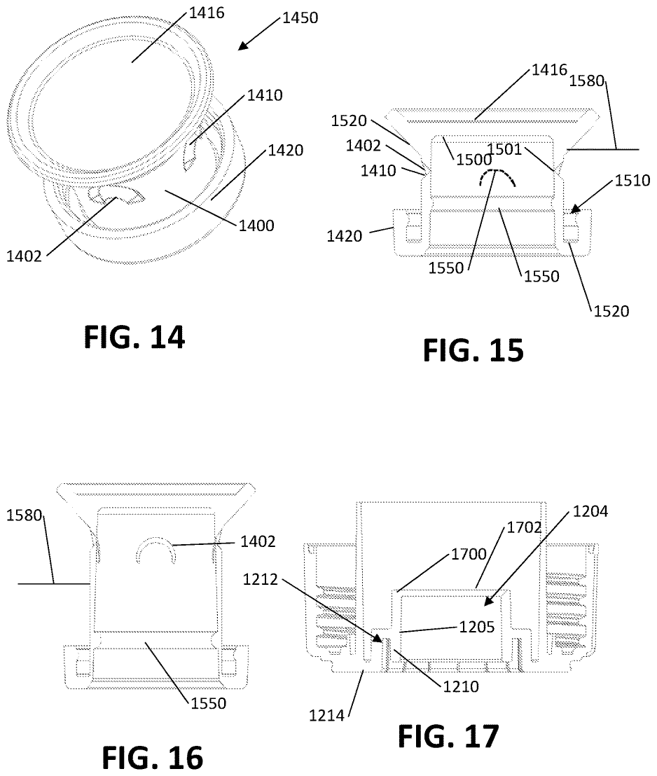

FIGS. 14 through 16 show an exemplary stretch valve 1150. Stretch valve 1150 is made of a resilient elastomeric material. Stretch valve 1150 may be made of, for example, one or more elastomers, rubber, silicone, urethane, thermoplastic elastomer, latex, polyisoprene. Accordingly, stretch valve 1150 may be stretched and will return to its original shape. Stretch valve 1150 includes a valve cap 1416, a valve cap lower surface 1500, a retention flange 1420, an annular channel 1520, a sealing bead 1550, one or more openings 1402 and a valve seal surface 1520.

The one or more “openings” in the stretch valves disclosed herein may also be referred to as fluid passageways. Exemplary fluid passageways disclosed herein may have circular cross-sections, elliptical cross-sections, oval cross-sections, elongated cross-sections. The fluid passageways are smooth and curve-continuous along the cross-sections. There are no sharp edges. There are no corners. The fluid passageways are devoid of stress concentrations. The fluid passageways are smooth along the cross-sections.

Stretch valve 1150 is a normally closed valve. FIG. 15 illustrates stretch valve 1150 in an unstretched position. The term “unstretched position” does not mean that the valve body is not under some tension. Indeed, preferably the valve body is under some tension when the stretch valve 1150 is secured to the closure 1106 and in the closed position so that a good seal is made between the valve seal 1520 and the valve seat 1700. The term unstretched position may be synonymous with the closed position.

When the stretch valve 1106 is secured to closure 1106 the valve cap 1406 is located above the top surface 1702 of valve seat 1700, retention flange 1420 is located in retention channel 1212, and lower cylindrical wall 1210 is located in the annular channel 1520 of stretch valve 1150. The valve seal 1520 is sealed against the valve seat 1700, and the stretch valve 1106 is secured to closure 1106.

In addition, the body 1400 of stretch valve 1150 is located on the interior of cylindrical wall 1205 when connected to closure 1106. In some instances, having the body 1400 of stretch valve 1150 on the interior of cylindrical wall 1205 prevents the valve from miss-seating and leaking. In addition, when the stretch valve 1150 is located inside the interior of cylindrical wall 1205 the stretch valve 1150 provides a superior seal. The seal is superior because the stretch valve 1150 seals and prevents against leaks in two different manners. First the valve seal 1520 of stretch valve 1150 seals against seat 1700. Second, the openings 1402 are closed off and sealed. Thus, any liquid that did seep between the valve seal 1520 of stretch valve 1150 and seat 1700 would be prevented from flowing out of container 1102 because openings 1402 are closed.

When the stretch valve 1106 is in the unstretched or closed position, openings 1402 are located below the top surface 1702 of the cylindrical wall 1205 of the closure. Line 1580 indicates the location of the top surface 1702 of cylindrical wall when valve 1106 is in the closed position. In addition, valve seal 1520 is seated against valve seat 1700 and fluid is prevented from flowing out of the container 1102. In addition, if container 1102 is squeezed compressed during transport, storage, or installation, the increased pressure may cause the valve seal 1520 to seat harder against valve seat 1700 ensuring that the fluid cannot leak out of container 1102. Thus, stretch valve 1150 seals in multiple ways.

FIG. 16 illustrates stretch valve 1106 in a stretched or open position. In the stretched or open position, openings 1402 are located above the top surface 1702 cylindrical projection 1205. The stretched or open position occurs when the lower surface 1500 of the valve cap 1416 is contacted by the top surface 1220 of valve post 1170 and moved upward or inward to stretch valve 1106. Accordingly, fluid may flow through openings 1402, through apertures 1180 in valve post 1170, through passage 1182. In this manner, liquid may flow from container 1102 into reservoir 1106. In addition, in some systems, air can flow out of reservoir 1106 and into container 1102.

When the refill unit 1100 is inserted into the dispenser 1200, sealing bead 1550, which is located on the inside of valve body and seals against valve post 1700 to prevent any fluid from passing between the stretch valve 1106 and the outside of valve post 1700. Stretch valve 1106 may have more than one sealing bead 1550. Optionally, a sealing bead (not shown), such as, for example, an o-ring, may be located on the valve post 1700. It is preferable to have the sealing bead 1550 located on the valve body 1400 because the refill unit 1400 is removed and replaced with a new refill unit when the refill unit 1400 is empty. Accordingly, each time the refill unit is replaced, a new sealing bead 1550 is provided, thus, eliminating issues with a seal on the valve post 1700 wearing out and leaking. When the refill unit 1100 is lifted off of the valve post 1700, the stretch valve 1150 closes and prevents fluid from leaking out of the refill unit 1100. Optionally, valve post 1700 may be tapered (as shown). When valve post 1700 is tapered, the valve body may seal radially against the tapered outside surface of the valve post 1700 and a sealing bead 1550 may not be required.

The one or more openings 1402 have a crescent shape with a sloped surface 1410 that terminates proximate the inside wall 1502 of valve body 1402. This results in the one or more openings 1402 being sealed during the manufacturing and assembly process. In other words, the one or more openings 1402 are not openings when inserted in the closure 1106. The first time stretch valve 1150 is stretched or fully opened, the very thin piece of elastomeric material proximate the inner wall 1502, tears or breaks and the one or more openings allow fluid to flow therethrough. Forming the one or more openings 1402 as described above aids in manufacturing the stretch valve 1150. In addition, because there are no openings in the stretch valve 1150, until its first use, the possibility of the stretch valve 1150 leaking during shipping and handling is further reduce. In addition, the one or more openings 1402 may have a larger area opening on the exterior of the valve body 1400 and a smaller area opening on the interior of valve body 1400.

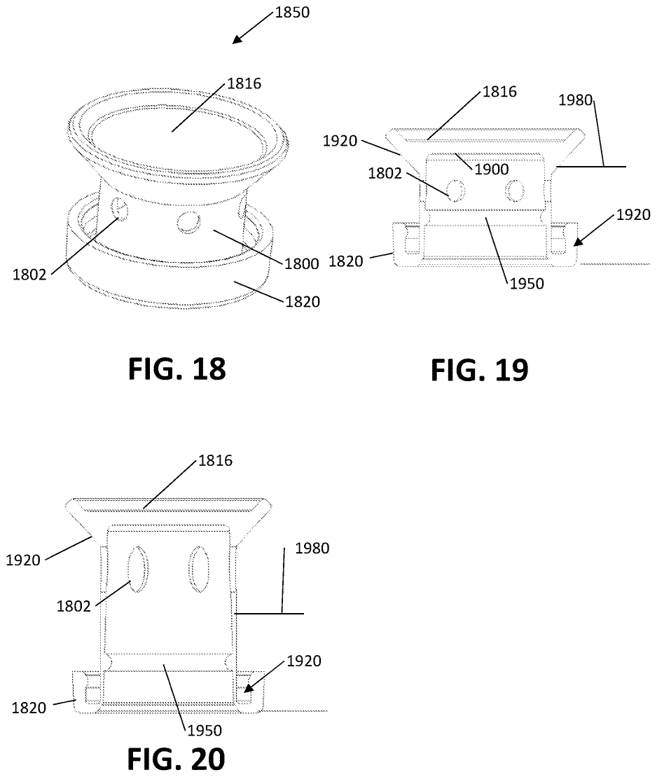

FIGS. 18 through 19 show an exemplary stretch valve 1800. Stretch valve 1800 is made of a resilient elastomeric material. Stretch valve 1800 may be made of, for example, one or more elastomers, rubber, silicone, urethane, thermoplastic elastomer, latex, polyisoprene. Accordingly, stretch valve 1800 may be stretched and will return to its original shape. Stretch valve 1800 includes a valve cap 1816, a valve cap lower surface 1900, a retention flange 1820, an annular channel 1920, a sealing bead 1950, one or more openings 1802 and a valve seal surface 1920.

Stretch valve 1800 is a normally closed valve. FIG. 19 illustrates stretch valve 1800 in an unstretched position. The term “unstretched position” does not mean that the valve body is not under some tension. Indeed, preferably the valve body is under some tension when the stretch valve 1800 is secured to the closure 1106 and in the closed position so that a good seal is made between the valve seal 1920 and the valve seat 1700. The term unstretched position may be synonymous with the closed position.

When the stretch valve 1800 is secured to closure 1106 the valve cap 1806 is located above the top surface 1702 of valve seat 1700, retention flange 1820 is located in retention channel 1212, and lower cylindrical wall 1210 is located in the annular channel 1920 of stretch valve 1800. The valve seal 1920 is sealed against the valve seat 1700, and the stretch valve 1800 is secured to closure 1106.

In addition, the body 1800 of stretch valve 1800 is located on the interior of cylindrical wall 1205 when connected to closure 1106. In some instances, having the body 1400 of stretch valve 1150 on the interior of cylindrical wall 1205 prevents the valve from miss-seating and leaking.

When the stretch valve 1800 is in the unstretched or closed position, openings 1802 are located below the top surface 1802 of the cylindrical wall 1205 of the closure. Line 1880 indicates the location of the top surface 1702 of cylindrical wall when valve 1880. In addition, valve seal 1920 is seated against valve seat 1700 and fluid is prevented from flowing out of the container. In addition, if the container is squeezed compressed during transport, storage, or installation, the increased pressure may cause the valve seal 1920 to seat harder against valve seat 1700 ensuring that the fluid cannot leak out of container.

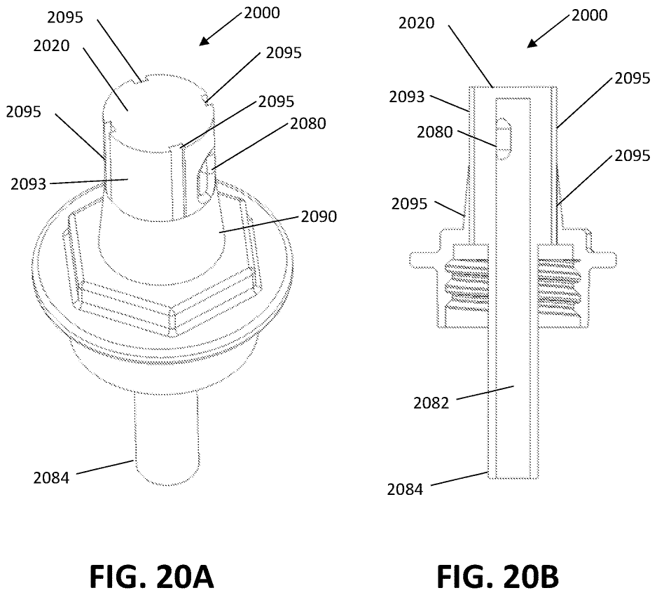

FIG. 20 illustrates stretch valve 1800 in a stretched or open position. In the stretched or open position, openings 1802 are located above the top surface 1702 cylindrical projection 1205. The stretched or open position occurs when the lower surface 1900 of the valve cap 1816 is contacted by the top surface 1220 of valve post 1170 and moved upward or inward to stretch valve 1800. Accordingly, fluid may flow through openings 1802, through apertures 1180 in valve post 1170, through passage 1182. In this manner, liquid may flow from container 1102 into reservoir 1106. In addition, in some systems, air can flow out of reservoir 1106 and into container 1102.

When the refill unit 1100 is inserted into the dispenser 1200, sealing bead 1950, which is located on the inside of valve body and seals against valve post 1700 to prevent any fluid from passing between the stretch valve 1800 and the outside of valve post 1700. Stretch valve 1800 may have more than one sealing bead 1950. Optionally, a sealing bead (not shown), such as, for example, an o-ring, may be located on the valve post 1700. It is preferable to have the sealing bead 1950 located on the valve body 1800 because the refill unit 1100 is removed and replaced with a new refill unit when the refill unit 1100 is empty. Accordingly, each time the refill unit is replaced, a new sealing bead 1950 is provided, thus, eliminating issues with a seal on the valve post 1700 wearing out and leaking. When the refill unit 1100 is lifted off of the valve post 1700, the stretch valve 1150 closes and prevents fluid from leaking out of the refill unit 1100. Optionally, valve post 1700 may be tapered (not shown). When valve post 1700 is tapered, the valve body may seal radially against the tapered outside surface of the valve post 1700 and a sealing bead 1950 may not be required.

The one or more openings 1820 are circular openings. In some instances, the circular openings tend to elongate into ovel openings when the valve is stretched. Other opening shapes are contemplated for the stretch valves disclosed herein. Such shapes may include square or rectangular shapes, oval shapes, and the like. In addition, the openings may be slits that are substantially closed when the stretch valve is closed and open when the stretch valve is opening. The one or more openings in the stretch valves are shown as being in a horizontal plane with respect to the valve body, however, some openings may be located above the height of other openings.

FIGS. 20A and 20B illustrate an exemplary valve post 2000. Valve post 2000 may be used in any of the dispensers disclosed herein. Valve post 2000 includes a valve contact surface 2020 and a valve post body 2093. Valve post body 2093 has aa tapered or flared position 2090. Valve post 2200 includes one or more apertures 2080 through the valve post body 2093 providing a fluid flow path through valve post 2000 to an interior hollow passage 2082. A tube 2084 extends downward into reservoir (not shown). Valve post 2000 includes one or more air passages or channels 2095 that allow air in the reservoir (not shown) to flow up into a container (not shown) as liquid is drawn out of the container. The one or more air passages or channels 2095 extend downward along the valve post body 2093 and become enclosed passageways as they pass through the tapered portion 2090. When a refill unit (not shown) is inserted over valve post 2000, the body of the stretch valve forms a seal around valve post 2000. Preferably the seal is located on the tapered section. A sealing bead on the stretch valve body (not shown) may or not be used to form the seal.

The one or more air passage 2095 do not need to extend along the entire valve post 2000. In addition, the one or more air passages 2095 are preferably sized so that the surface tension of the fluid in the container (not shown) prevents liquid from flowing down the one or more air passages 2095.

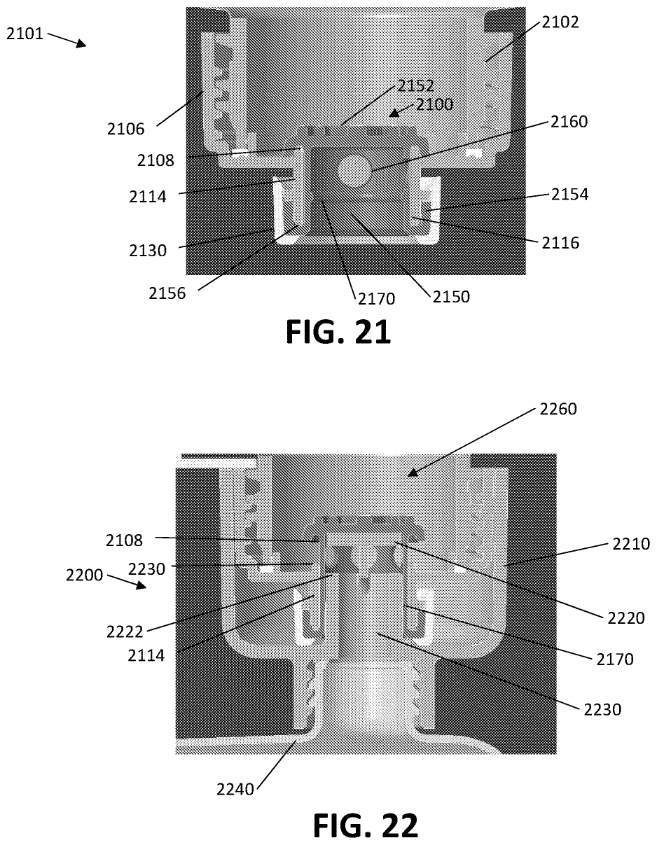

FIGS. 21 and 22 illustrate another exemplary stretch valve 2100 in a portion of a refill unit 2101. Refill unit 2101 has a closure 2106 secured thereto. Closure 2160 includes a cylindrical wall 2114. The top of cylindrical wall 2114 forms a valve seat, and the bottom of cylindrical wall 2114 is received in annular channel 1520 for securing stretch valve 2100 to the closure.

Stretch valve 2100, which is show in its unstretched or open position, includes a valve body 2150, a retention flange 2154, a lower annular channel 2116, a valve sealing surface 2108, a valve cap 2152, one or more openings 2160 and a sealing bead 2170. Stretch valve 2100 is made of a resilient elastomeric material. Stretch valve 2100 may be made of, for example, one or more elastomers, rubber, silicone, urethane, thermoplastic elastomer, latex, polyisoprene.

An optional valve retaining cap 2130 may be used to better secure the stretch valve 2100 to closure 2106. The components of stretch valve 2100 that are similar to those described above and are not repeated herein but apply to this stretch valve as well.

FIG. 22 illustrates the refill unit 2101 inserted in a portion of dispenser 2200. Dispenser 2200 includes a receptacle 2210 and a valve post 2220. The valve post 2220 includes one or more openings 2222 from the outside of the valve post 2220 to an interior passageway 2230, which leads to the interior of a reservoir 2240. When the refill unit 2101 is inserted into the dispenser 220, the valve post 2220 engages the stretch valve 2100, lifting the valve seal 2108 off of the valve seat 2230 and the one or more openings 2160, or at least a portion of the one or more openings 2160 move above the top of cylindrical wall 2114 allowing fluid to flow between the interior of the container 2260 and the reservoir 2240. When the refill unit 2101 is lifted off of the valve post 2220, the stretch valve 2100 closes and prevents fluid from leaking out of the refill unit 2100.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification. This listing of claims will replace all prior versions, and listings, of claims in this application.

What is claimed is:

1. A refill unit for a soap or sanitizer dispenser comprising:
a container;
a closure;
the closure having;
a cylindrical wall forming an opening through the closure;
the cylindrical wall having an upper surface that forms a valve seal;
the cylindrical wall having a lower portion;
a stretch valve;
the stretch valve having
an annular wall;
a valve seal;
a retention flange;
an annular channel; and
one or more fluid passageways through the annular wall;
wherein at least a portion of the annular all is located on the interior of the cylindrical wall;
wherein the lower portion of the cylindrical wall is located in the annular channel;
wherein the stretch valve stretches to move from a closed position to an open position;
wherein the stretch valve is a normally closed valve;
wherein the one or more fluid passageways are located below the valve seat when the stretch valve is in a closed position; and
wherein the one or more fluid passageways are at least partially located above the valve seat when the vale is in an open position.

2. The refill unit of claim 1 wherein the closure comprises a retention channel and wherein the retention channel receives the retention flange of the stretch valve.

3. The refill unit of claim 1 further comprising a valve retention member that connects to the closure.

4. The refill unit of claim 3 wherein the valve retention member comprises a retention channel and wherein the retention channel receives the retention flange of the stretch valve.

5. The refill unit of claim 1 wherein the valve seat is an angled surface.

6. The refill unit of claim 1 wherein the valve seat is an annular channel.

7. The refill unit of claim 1 wherein the stretch valve further comprising a sealing bead.

8. The refill unit of claim 7 wherein the sealing bead is located on an interior surface of the annular wall.

9. The refill unit of claim 1 wherein the fluid passageways have a sloped opening.

10. The refill unit of claim 1 wherein the fluid passageways have a circular shape.

11. The refill unit of claim 1 wherein the fluid passageways have an oval shaped opening.

12. (canceled)

13. The refill unit of claim 1 wherein the cross-sectional shape of the fluid passageways are curve-continuous.

14. A refill unit for a soap or sanitizer dispenser comprising:
a container;
a closure;
the closure having;
a cylindrical wall forming an opening through the closure;
the cylindrical wall having an upper surface that forms a valve seal;
the cylindrical wall having a lower extending portion;
a stretch valve;
the stretch valve having
an annular wall;
a valve seal;
a retention flange;
an annular channel;
one or more openings through the annular wall; and
a sealing bead located on the interior of the valve body;
wherein at least a portion of annular wall is located on the interior of the cylindrical wall;
wherein the lower extending portion of the cylindrical wall is located in the annular channel of the stretch valve;
wherein the one or more openings are located below the valve seat when the stretch valve is in a closed position; and
wherein the one or more openings are at least partially located above the valve seat when the vale is in an open position.

15. The refill unit of claim 14 wherein the fluid passageways have a sloped opening.

16. The refill unit of claim 14 wherein the fluid passageways have a circular shape.

17. The refill unit of claim 14 wherein the fluid passageways have an oval shaped opening.

18-19. (canceled)

20. A refill unit for a soap or sanitizer dispenser comprising:
a container;
a closure;
the closure having;
a cylindrical wall forming an opening through the closure;
the cylindrical wall having an upper surface that forms a valve seat;
the cylindrical wall having a lower extending portion; and
a stretch valve;
the stretch valve having
an annular wall;
a valve seal;
a retention flange;
an annular channel;
one or more fluid passageways through the annulare wall; and
wherein the one or more fluid passageways have an outer opening on the exterior of the annular wall and an inner opening on the interior of the annular wall;
wherein the outer opening is larger than the inner opening;
wherein at least a portion of the annular wall is located on the interior of the cylindrical wall;
wherein the lower extending portion of the cylindrical wall is located in the annular channel of the stretch valve;
wherein the one or more openings are located below the valve seat when the stretch valve is in a closed position; and
wherein the one or more openings are at least partially located above the valve seat when the vale is in an open position.

21. The refill unit of claim 20 wherein the fluid passageways have a sloped opening.

22. The refill unit of claim 20 wherein the fluid passageways have a circular shape.

23. The refill unit of claim 20 wherein the fluid passageways have an oval shaped opening.

24-37. (canceled)
